(19) United States
(12) Patent Application Publication
(10) Pub. No.: US 2023/0289588 A1
(43) Pub. Date: Sep. 14, 2023

(54) Deep Neural Network Processing Device with Decompressing Module, Decompressing Method and Compressing Method

(71) Applicant: ALTEK SEMICONDUCTOR CORPORATION, Hsinchu City (TW)

(72) Inventors: Chun-Feng Huang, Hsinchu City (TW); Jung-Hsuan Liu, Hsinchu City (TW); Chao-Wen Lin, Hsinchu City (TW)

(73) Assignee: ALTEK SEMICONDUCTOR CORPORATION, Hsinchu City (TW)

(21) Appl. No.: 17/691,145

(22) Filed: Mar. 10, 2022

(51) Int. Cl. G06N 3/08

(52) U.S. Cl. CPC G06N 3/08

(57) ABSTRACT

A deep neural network (DNN) processing device with a decompressing module, comprises a storage module, for storing a plurality of binary codes, a coding tree, a zero-point value and a scale; a decompressing module, coupled to the storage module, for generating a quantized weight array according to the plurality of binary codes, the coding tree and the zero-point value wherein the quantized weight array is generated according to an aligned quantized weight array and the zero-point value; and a DNN processing module, coupled to the decompressing module, for processing an input signal according to the quantized weight array and the scale.

### BACKGROUND OF THE INVENTION

### 1. Field of the Invention

The present invention relates to a device and methods used in an embedded system, and more particularly, to a deep neural network processing device with a decompressing module, a decompressing method and a compressing method used in the embedded system.

### 2. Description of the Prior Art

With the development of deep-learning technologies, the performance of artificial intelligence (AI), especially in tasks related to perception and prediction, has greatly surpassed existing technologies. However, since a main product of the deep-learning technologies is a deep neural network model which includes a large amount (e.g., million) of weights, a heavy computation load and a high memory requirement are required to achieve a high model precision, which limit the development of the deep-learning technologies in the field of an embedded system. Thus, how to achieve a balance between a model precision, a computation load and a memory requirement for the deep-learning technologies in the field of the embedded system is an essential problem to be solved.

### SUMMARY OF THE INVENTION

The present invention therefore provides a deep neural network processing device with a decompressing module, a decompressing method and a compressing method to solve the abovementioned problem.

A deep neural network (DNN) processing device with a decompressing module, includes a storage module, for storing a plurality of binary codes, a coding tree, a zero-point value and a scale; the decompressing module, coupled to the storage module, for generating a quantized weight array according to the plurality of binary codes, the coding tree and the zero-point value, wherein the quantized weight array is generated according to an aligned quantized weight array and the zero-point value; and a DNN processing module, coupled to the decompressing module, for processing an input signal according to the quantized weight array and the scale.

A decompressing method, includes receiving a plurality of binary codes, a coding tree, a zero-point value and a scale; generating an aligned quantized weight array according to the plurality of binary codes and the coding tree; generating a quantized weight array according to the aligned quantized weight array and the zero-point value; and transmitting the quantized weight array, the zero-point value and the scale.

A compressing method, includes receiving a quantized weight array, a zero-point value and a scale; generating an aligned quantized weight array according to the quantized weight array and the zero-point value; generating a plurality of binary code and a coding tree according to the aligned quantized weight array; and transmitting the plurality of binary codes, the coding tree, the zero-point value and the scale to a storage module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a deep neural network processing device according to an example of the present invention.

FIG. 2 is a schematic diagram of a decompressing module according to an example of the present invention.

FIG. 3 is a flowchart of a process according to an example of the present invention.

FIG. 4 is a flowchart of a process according to an example of the present invention.

### DETAILED DESCRIPTION

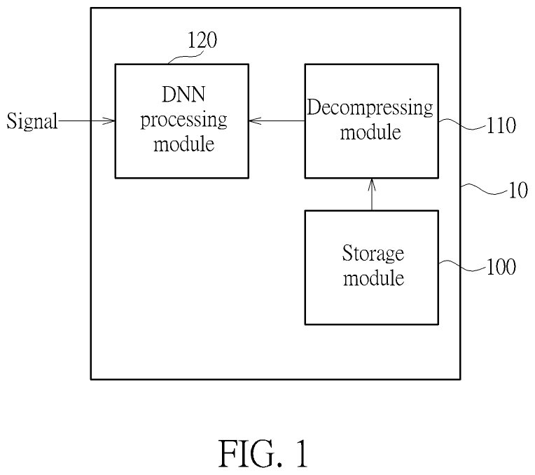

FIG. 1 is a schematic diagram of a deep neural network (DNN) processing device 10 according to an example of the present invention. The DNN processing device 10 includes a storage module 100, a decompressing module 110 and a DNN processing module 120. The storage module 100 stores a plurality of binary codes (or any suitable codes), a coding tree, a zero-point value and a scale. The decompressing module 110 is coupled to the storage module 100, and generates (e.g., restores) a quantized weight array (e.g., parameter matrix) according to (e.g., by using) the plurality of binary codes, the coding tree and the zero-point value. The quantized weight array is generated according to an aligned quantized weight array and the zero-point value. The DNN processing module 120 is coupled to the decompressing module 110, and processes an input signal (e.g., as shown in FIG. 1) according to the quantized weight array and the scale.

In one example, the DNN processing device 10 includes (e.g., is or is configured as) an image signal processing (ISP) device, a digital signal processing (DSP) device, any suitable device for processing a DNN model or related operation, or combination thereof, but is not limited thereto.

In one example, the DNN processing module 120 is configured as an artificial intelligence (AI) engine to convert the input signal to required information (e.g., for processing a DNN model or related operation), wherein the input signal may be obtained from a sensor (e.g., an image sensor of a camera). In one example, the AI engine includes a graphic processing unit (GPU), any suitable electronic circuit for processing computer graphics and images, or combination thereof, but is not limited thereto. In one example, the DNN processing module 120 is configured as an image signal processing module, the input signal is an image signal, or required information is an image data.

In one example, the DNN processing device 10 further includes a controlling module (not shown in FIG. 1). The controlling module is coupled to the storage module 100, and executes a plurality of instructions (e.g., binary codes) stored in the storage module 100, to control the decompressing module 110 and the DNN processing module 120.

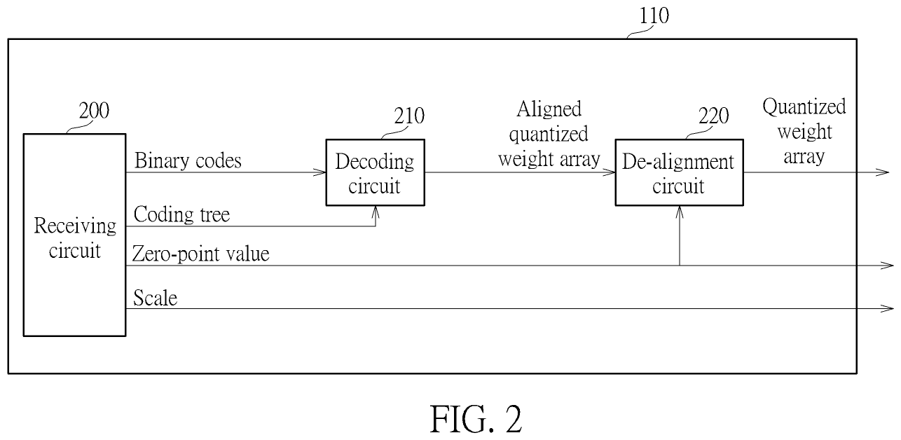

FIG. 2 is a schematic diagram of the decompressing module 110 according to an example of the present invention. The decompressing module 110 includes a receiving circuit 200, a decoding circuit 210 and a de-alignment circuit 220. The receiving circuit 200 receives the plurality of binary codes, the coding tree, the zero-point value and the scale (e.g., from the storage module 100). The decoding circuit 210 is coupled to the receiving circuit 200, and generates the aligned quantized weight array according to the plurality of binary codes and the coding tree. The de-alignment circuit 220 is coupled to the receiving circuit 200 and the decoding circuit 210, and generates (e.g., restores) the quantized weight array according to the aligned quantized weight array and the zero-point value.

In one example, the decompressing module 110 transmits (e.g., stores) the quantized weight array, the zero-point value and the scale (e.g., in a register of the DNN processing device 10).

In one example, the decoding circuit 210 decodes the plurality of binary codes according to the coding tree to generate the aligned quantized weight array. In one example, the de-alignment circuit 220 adds the zero-point value to the aligned quantized weight array to generate the quantized weight array. That is, parameters with values in the aligned quantized weight array are added by the zero-point value. In one example, the de-alignment circuit 220 includes an adder which is a digital circuit for performing an addition on the values.

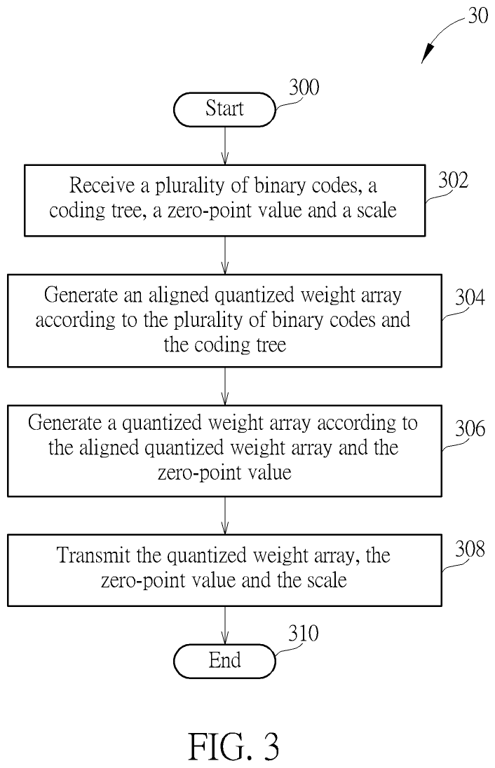

The decompressing method of the decompressing module 110 mentioned above can be summarized into a process 30 shown in FIG. 3 which includes the following steps:

Step 300: Start.

Step 302: Receive a plurality of binary codes, a coding tree, a zero-point value and a scale.

Step 304: Generate an aligned quantized weight array according to the plurality of binary codes and the coding tree.

Step 306: Generate a quantized weight array according to the aligned quantized weight array and the zero-point value.

Step 308: Transmit (e.g., store) the quantized weight array, the zero-point value and the scale.

Step 310: End.

According to the process 30, the quantized weight array is restored by using the zero-point value.

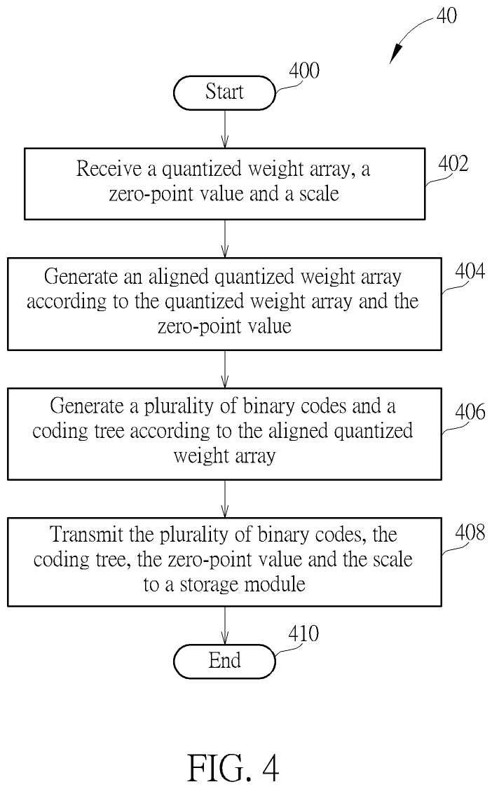

The compressing method for compressing the quantized weight array mentioned above can be summarized into a process 40 shown in FIG. 4 which includes the following steps:

Step 400: Start.

Step 402: Receive a quantized weight array, a zero-point value and a scale.

Step 404: Generate an aligned quantized weight array according to the quantized weight array and the zero-point value.

Step 406: Generate a plurality of binary codes and a coding tree according to the aligned quantized weight array.

Step 408: Transmit the plurality of binary codes, the coding tree, the zero-point value and the scale to a storage module (e.g., the storage module 100 in the FIG. 1).

Step 410: End.

According to the process 40, the quantized weight array is aligned by using the zero-point value before generating the plurality of binary codes and the coding tree.

In one example, the step of generating the aligned quantized weight array according to the quantized weight array and the zero-point value (i.e., step 404) includes subtracting the zero-point value from the quantized weight array to generate the aligned quantized weight array. That is, parameters with values in the quantized weight array are subtracted by the zero-point value.

In one example, the step of generating the plurality of binary codes and the coding tree according to the aligned quantized weight array (i.e., step 406) includes generating (e.g., calculating) the coding tree according to the aligned quantized weight array, and converting (e.g., each parameter (e.g., weight) of) the aligned quantized weight array to the plurality of binary codes according to (e.g., by using) the coding tree.

In one example, the coding tree is generated according to a plurality of aligned quantized weight arrays (e.g., statistics of all parameters in the plurality of aligned quantized weight arrays corresponding to a DNN model), wherein each of the plurality of aligned quantized weight arrays is generated according to the above step 404.

In one example, the quantized weight array includes a first plurality of parameters (e.g., weights) with a first plurality of values in a range of an 8-bits integer (i.e., the first plurality of values are in an 8-bit fixed-point format). In one example, the first plurality of parameters are corresponding to or generated according to (e.g., quantized from) a second plurality of parameters with a second plurality of values in a range of a real number (i.e., the second plurality of values are in a 32-bits float-point format).

In one example, the first plurality of parameters are generated according to the second plurality of parameters according to an asymmetric quantization scheme. The asymmetric quantization scheme is defined according to the following equation:

r=S(q−Z), (Eq. 1)

where r is the real number, S is the scale, q is the 8-bits integer, and Z is the zero-point value.

In detail, an interval between the minimum value of the second plurality of values and the maximum value of the second plurality of values is equally divided into 256 parts. Then, the 256 parts are mapped to all integers in the range of the 8-bits integer (e.g., 256 integers from −128 to 127), respectively, according to the scale. For example, values of the second plurality of values belonged to the first part of the 256 parts are mapped to the minimum integer in the range of the 8-bits integer (e.g., −128), values of the second plurality of values belonged to the second part of the 256 parts are mapped to the second integer in the range of the 8-bits integer (e.g., −127), . . . , and values of the second plurality of values belonged to the last part of the 256 parts are mapped to the maximum integer in the range of the 8-bits integer (e.g., 127).

In another example, the first plurality of parameters are generated according to the second plurality of parameters according to an asymmetric quantization scheme. The symmetric quantization scheme is defined according to the following equation:

r=Sq, (Eq. 2)

where the meanings of r, S and q are the same as those in the equation (Eq. 1), and are not repeated herein.

In one example, the zero-point value includes (e.g., is) a third value in the first plurality of values mapped by a value of 0 in the second plurality of values. According to the asymmetric quantization scheme defined as the equation (Eq. 1), q is Z when r is the value of 0. That is, Z in the first plurality of values is the zero-point value. According to the symmetric quantization scheme in the equation (Eq. 2), q is the value of 0 when r is the value of 0. That is, the value of 0 in the first plurality of values is the zero-point value. Thus, the zero-point values obtained from the asymmetric quantization scheme and the symmetric quantization scheme are different.

In one example, the second plurality of parameters (e.g., weights) are determined according to (e.g., given by) the DNN model. In one example, the second plurality of parameters are generated according to (e.g., trained) a plurality of input signal. In one example, the coding tree includes (e.g., is) a Huffman tree. That is, for the decompressing module 110, the decoding circuit 210 performs a Huffman decoding on the plurality of binary codes according to the Huffman tree to generate the aligned quantized weight array. In addition, for the compressing method in the process 40, a Huffman encoding is performed on (e.g., each parameter (e.g., weight) of) the aligned quantized weight array according to the Huffman tree to generate the plurality of binary codes. In one example, the above mentioned Huffman coding (e.g., encoding or decoding) includes an entropy coding (e.g., weight coding) algorithm used for lossless data decompressing or compressing as known by those skilled in the field. In one example, the scale includes (e.g., is) a positive real number (e.g., a floating-point number), which is used for scaling the second plurality of parameters to the first plurality of parameters, i.e., for converting the 32-bits float-point format to the 8-bit fixed-point format.

In one example, a plurality of quantized weight arrays generated according to the asymmetric quantization scheme defined according to the equation (Eq. 1) and are aligned by using their respective zero-point values. Thus, a distribution of a plurality of parameters with a plurality of values in the plurality of quantized weight arrays is concentrated and bits used for compressing the plurality of quantized weight arrays are reduced. Thus, the plurality of parameters in the asymmetrical 8-bit fixed-point format achieve a compressing rate close to the plurality of parameters in the symmetrical 8-bit fixed-point format, and maintain advantages of a high resolution of the parameters in the asymmetrical 8-bit fixed-point format. As a result, a memory requirement (e.g., a usage of memory) for storing the bits is reduced accordingly.

In one example, the plurality of quantized weight arrays generated according to the above asymmetric quantization scheme are further pruned by setting smaller values (e.g., values closing to the value of 0) to the value of 0. Thus, the value of 0 becomes an extreme mode in the plurality of quantized weight arrays, and bits used for compressing the plurality of quantized weight arrays are reduced (e.g., only a bit is needed for encoding the value of 0). As a result, a compressing rate of the plurality of quantized weight arrays is increased, and a memory requirement (e.g., a usage of memory) for storing the bits is reduced accordingly.

It should be noted that, realizations of the DNN processing device 10 (including the modules therein) are various. For example, the modules mentioned above may be integrated into one or more modules. In addition, the DNN processing device 10 may be realized by hardware (e.g., circuit), software, firmware (known as a combination of a hardware device, computer instructions and data that reside as read-only software on the hardware device), an electronic system or a combination of the modules mentioned above, but is not limited herein. Realizations of the decompressing module 110 (including the circuits therein) are various. For example, the circuits mentioned above may be integrated into one or more circuits. In addition, the decompressing module 110 may be realized by hardware (e.g., circuit), software, firmware (known as a combination of a hardware device, computer instructions and data that reside as read-only software on the hardware device), an electronic system or a combination of the circuit s mentioned above, but is not limited herein.

To sum up, the present invention provides the DNN processing device 10 with the decompressing module 110, the decompressing method and the compressing method. According to the compressing method, the quantized weight arrays are quantized by using the asymmetric quantization scheme and are aligned by using the zero-point values, respectively, and/or are pruned by using the value of 0. Thus, bits used for compressing the quantized weight arrays are reduced without sacrificing the performance of the DNN model, and a compressing rate of the quantized weight arrays is increased and the memory requirement for storing the weight is reduced. According to the decompressing module 110 and the decompressing method, stored binary codes are restored to the quantized weight arrays using dedicated circuits. Thus, the heavy computation load and the high memory requirement are decreased and the model precision is retained. As a result, the balance between the model precision, the computation load and the memory requirement for the deep-learning technologies in the field of the embedded system is achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A deep neural network (DNN) processing device with a decompressing module, comprising:
a storage module, for storing a plurality of binary codes, a coding tree, a zero-point value and a scale;
the decompressing module, coupled to the storage module, for generating a quantized weight array according to the plurality of binary codes, the coding tree and the zero-point value, wherein the quantized weight array is generated according to an aligned quantized weight array and the zero-point value; and
a DNN processing module, coupled to the decompressing module, for processing an input signal according to the quantized weight array and the scale.

2. The DNN processing device of claim 1, wherein the DNN processing module is configured as an artificial intelligence (AI) engine to convert the input signal to required information, wherein the input signal is obtained from a sensor.

3. The DNN processing device of claim 1, further comprising:
a controlling module, coupled to the storage module, for executing a plurality of instructions stored in the storage module, to control the decompressing module and the DNN processing module.

4. The DNN processing device of claim 1, wherein the decompressing module comprises:
a receiving circuit, for receiving the plurality of binary codes, the coding tree, the zero-point value and the scale;
a decoding circuit, coupled to the receiving circuit, for generating the aligned quantized weight array according to the plurality of binary codes and the coding tree; and
a de-alignment circuit, coupled to the receiving circuit and the decoding circuit, for generating the quantized weight array according to the aligned quantized weight array and the zero-point value.

5. The DNN processing device of claim 4, wherein the decoding circuit decodes the plurality of binary codes according to the coding tree to generate the aligned quantized weight array.

6. The DNN processing device of claim 4, wherein the de-alignment circuit adds the zero-point value to the aligned quantized weight array to generate the quantized weight array.

7. The DNN processing device of claim 1, wherein the quantized weight array comprises a first plurality of parameters with a first plurality of values in a range of an 8-bits integer.

8. The DNN processing device of claim 7, wherein the first plurality of parameters are corresponding to a second plurality of parameters with a second plurality of values in a range of a real number.

9. The DNN processing device of claim 8, wherein the zero-point value comprises a third value in the first plurality of values mapped by a value of 0 in the second plurality of values.

10. The DNN processing device of claim 1, wherein the coding tree comprises a Huffman tree or the scale comprises a positive real number.

11. A decompressing method, comprising:
receiving a plurality of binary codes, a coding tree, a zero-point value and a scale;
generating an aligned quantized weight array according to the plurality of binary codes and the coding tree;
generating a quantized weight array according to the aligned quantized weight array and the zero-point value; and
transmitting the quantized weight array, the zero-point value and the scale.

12. The decompressing method of claim 11, wherein the step of generating the aligned quantized weight array according to the plurality of binary codes and the coding tree comprises:
decoding the plurality of binary codes according to the coding tree to generate the aligned quantized weight array.

13. The decompressing method of claim 11, wherein the step of generating the quantized weight array according to the aligned quantized weight array and the zero-point value comprises:
adding the zero-point value to the aligned quantized weight array to generate the quantized weight array.

14. The decompressing method of claim 11, wherein the quantized weight array comprises a first plurality of parameters with a first plurality of values in a range of an 8-bits integer.

15. The decompressing method of claim 14, wherein the first plurality of parameters are corresponding to a second plurality of parameters with a second plurality of values in a range of a real number.

16. The decompressing method of claim 15, wherein the zero-point value comprises a third value in the first plurality of values mapped by a value of 0 in the second plurality of values.

17. The decompressing method of claim 11, wherein the coding tree comprises a Huffman tree or the scale comprises a positive real number.

18. A compressing method, comprising:
receiving a quantized weight array, a zero-point value and a scale;
generating an aligned quantized weight array according to the quantized weight array and the zero-point value;
generating a plurality of binary code and a coding tree according to the aligned quantized weight array; and
transmitting the plurality of binary codes, the coding tree, the zero-point value and the scale to a storage module.

19. The compressing method of claim 18, wherein the step of generating the aligned quantized weight array according to the quantized weight array and the zero-point value comprises:
subtracting the zero-point value from the quantized weight array to generate the aligned quantized weight array.

20. The compressing method of claim 18, wherein the step of generating the plurality of binary codes and the coding tree according to the aligned quantized weight array comprises:
generating the coding tree according to the aligned quantized weight array; and
convert the aligned quantized weight array to the plurality of binary codes according to the coding tree.

21. The compressing method of claim 18, wherein the quantized weight array comprises a first plurality of parameters with a first plurality of values in a range of an 8-bits integer.

22. The compressing method of claim 21, wherein the first plurality of parameters are generated according to a second plurality of parameters with a second plurality of values in a range of a real number.

23. The compressing method of claim 22, wherein the zero-point value comprises a third value in the first plurality of values mapped by a value of 0 in the second plurality of values.

24. The compressing method of claim 22, wherein the second plurality of parameters are determined according to a deep neural network (DNN) model.

25. The compressing method of claim 18, wherein the coding tree comprises a Huffman tree or the scale comprises a positive real number.
